(19) United States
(12) Patent Application Publication
(10) Pub. No.: US 2026/0150175 A1
(43) Pub. Date: May 28, 2026

(54) CONNECTION ASSEMBLY, PLASMA PROCESS FLOW SUPPLY SYSTEM, PLASMA PROCESS SYSTEM, AND METHOD FOR OPERATING A PLASMA PROCESS

(71) Applicant: TRUMPF Hüttinger GmbH + Co. KG, Freiburg (DE)

(72) Inventor: Philip FEUERSCHUETZ, Bad Krozingen (DE)

(21) Appl. No.: 19/278,880

(22) Filed: Jul. 24, 2025

Related U.S. Application Data
(63) Continuation of application No. PCT/EP2024/051665, filed on Jan. 24, 2024.

(30) Foreign Application Priority Data
Jan. 25, 2023 (DE) 10 2023 101 847.7

(51) Int. Cl. H05H 1/00; H05H 1/46

(52) U.S. Cl. CPC H05H 1/01; H05H 1/46

(57) ABSTRACT

A connection assembly for a plasma process flow supply system, including a first inner conductor configured to provide a first direct voltage via a first direct current (DC) power supply; a second inner conductor configured to provide a second direct voltage via a second DC power supply; and an outer conductor which surrounds the first and second inner conductor to shield the first and second inner conductor and displays the reference potential of the first and second inner conductor. The connection assembly is configured to be connected to: a plasma process assembly, the first and second DC power supply, and a high frequency (HF) power supply, and/or an impedance adaptation circuit. The connection assembly is configured to guide an HF power signal related to the outer conductor via the first and second inner conductor to supply the plasma process assembly with HF power via the HF power supply.

### CROSS REFERENCE TO RELATED APPLICATIONS

This application is a continuation of International Application No. PCT/EP2024/051665 (WO 2024/156756A1 ), filed on Jan. 24, 2024, and claims benefit to German Patent Application No. DE 10 2023 101 847.7 filed on Jan. 25, 2023. The aforementioned applications are hereby incorporated by reference herein.

### FIELD

The present invention relates to a connection assembly for a plasma process flow supply system, a plasma process flow supply system, a plasma process system, and a method for operating a plasma process.

### BACKGROUND

Such a plasma process flow supply system may, for example, be part of a plasma process system in which a plasma process assembly is supplied with electrical power by means of a plurality of power supplies.

Such a plasma process assembly can, for example, be a plasma process chamber used for industrial plasma processes such as the surface treatment of workpieces, semiconductor manufacturing with plasma, or the processing of workpieces with gas lasers.

In such an application, the plasma process assembly serves to generate plasma.

For this purpose, a plasma process assembly can have two electrodes that are fed with two direct voltages, e.g., for supplying electrostatic chucks, and a high-frequency (HF) power signal for generating the plasma, hereinafter referred to as the HF power signal.

Typically, the plasma process assembly is connected to a plurality of DC power supplies and a high-frequency power supply, hereinafter referred to as an HF power supply.

The plasma process taking place in the plasma process assembly has the problem that the electrical load impedance of the plasma process assembly, which occurs during the process, depends on the conditions in the plasma process assembly and can vary greatly. In particular, the properties of the workpiece, electrodes, and gas conditions are taken into account.

For this reason, an impedance adaptation circuit is usually required to transform the impedance of the load to a nominal impedance of the HF power supply. Such an impedance adaptation circuit is usually placed between the HF power supply and the plasma process assembly, usually in the immediate vicinity of the plasma process assembly.

In addition to the impedance adaptation circuits, plasma process flow supply systems may also be provided with one or a plurality of filters in one or a plurality of filter boxes. Such a filter box has electrical circuits that serve to protect against unwanted currents, in particular reverse currents, with a frequency different from the useful frequency.

Such a filter box can be a circuit assembly arranged in a housing, which has a plurality of inputs for connecting a plurality of power supplies with, for example, different operating frequencies, one or a plurality of outputs and one or a plurality of filter circuits. For example, DC, AC and/or HF power supplies can be connected to the inputs.

The filter circuits ensure that connected power supplies do not interfere with each other by protecting them from unwanted currents of a different frequency relative to the input.

For this purpose, the filter circuits preferably have inductances and/or capacitances, which are often very expensive for the application in question due to the required current and voltage load capacity as well as the need for cooling.

The filter boxes can be arranged between the impedance adaptation circuit and the plasma process assembly.

All these components, such as DC power supplies, HF power supply or filter boxes, but in particular the impedance adaptation circuit and the plasma process assembly must be connected together in a plasma process flow supply system.

When fed with three different signals, such a connection in conventional assemblies means a level of design complexity, since a separate line is used for each signal.

In addition to the design complexity of such a connection assembly, this also results in costs for three connecting lines.

### SUMMARY

In an embodiment, the present disclosure provides a connection assembly for a plasma process flow supply system, including a first inner conductor configured to provide a first direct voltage by means of a first direct current (DC) power supply; a second inner conductor configured to provide a second direct voltage by means of a second DC power supply; and an outer conductor which surrounds the first and second inner conductor to shield the first and second inner conductor and displays the reference potential of the first and second inner conductor. The connection assembly is configured to be connected to: a plasma process assembly, the first and second DC power supply, and a high frequency (HF) power supply, or an impedance adaptation circuit and a plasma process assembly, and/or an impedance adaptation circuit, the first and second DC power supply, and an HF power supply. The connection assembly is configured to guide an HF power signal related to the outer conductor via the first and second inner conductor to supply the plasma process assembly with HF power by means of the HF power supply.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a connection assembly arranged in a plasma process system according to an embodiment of the present invention;

FIG. 2a, FIG. 2b, FIG. 2c and FIG. 2d show a plurality of different plasma process flow supply systems and plasma process systems with a connection assembly according to embodiments of the present invention; and

FIG. 3 shows a connection assembly with sensor according to an embodiment of the present invention.

### DETAILED DESCRIPTION

Embodiments of the present invention provide a connection assembly for a plasma process flow supply system which simplifies the design of a plasma process flow supply system.

According to embodiments of the present invention, a connection assembly for a plasma process flow supply system is proposed, having:
a first inner conductor which is designed to provide a first direct voltage by means of a first DC power supply,
a second inner conductor which is designed to provide a second direct voltage by means of a second DC power supply,
an outer conductor which surrounds the two inner conductors in order to shield same and displays the reference potential of the two inner conductors,
wherein the connection assembly is designed for connection to:
a plasma process assembly and two DC power supplies and one HF power supply or
an impedance adaptation circuit and a plasma process assembly and/or
an impedance adaptation circuit, the DC power supplies and an HF power supply;
wherein the connection assembly is designed to guide an HF power signal related to the outer conductor via the two inner conductors in order to supply the plasma process assembly with HF power by means of the HF power supply.

The connection assembly according to an embodiment of the present invention combines the provision of two direct voltages and the transmission of an HF power signal in a common assembly, thus simplifying the design of a plasma process flow supply system. HF power signal here means a power signal with power levels ≥500 W, in particular embodiments ≥1 kW, in particularly preferred embodiments ≥3 kW. HF means high frequency. In the plasma process field, HF refers to frequencies ≥2 MHz, but in particular frequencies ≥10 MHz and ≤200 MHz are meant.

Such a plasma process flow supply system typically has two DC power supplies, an HF power supply, and a connection assembly for connecting a possible load.

A possible load could be, for example, a plasma process assembly such as a plasma process chamber that has two electrodes. These electrodes usually require the supply of two DC signals and one HF signal, the former for use as electrostatic chucks, for example, and the latter for plasma generation, for example.

Optionally, additional components such as an impedance adaptation circuit or circuits or components as protective measures can also be part of a plasma process flow supply system. As a protective measure, one or a plurality of inductances and/or capacitances can be used, in particular embodiments one or a plurality of DC blocking capacitances or HF blocking inductances. A DC blocking capacitance is a capacitance that is designed and arranged to block a DC current. An HF blocking inductance is an inductance that is designed and arranged to significantly reduce, in particular embodiments to block, an HF current. These components can thus protect against unwanted DC or HF return currents.

A DC power supply is a power supply that is designed to provide power with direct voltage and direct current. This power can be pulsed or bipolar pulsed.

Reference potential refers to a voltage potential that has a constant potential relative to ground over a plurality of periods of the HF signal. In particular embodiments, it is ground itself.

For use of the connection assembly in a plasma process flow supply system, the inner conductors of the connection assembly can each be connected to a different DC power supply and, in addition, both inner conductors can be connected together to an HF power supply.

This allows a potential load, such as a plasma process chamber, to be supplied with three different signals via a single common assembly without the need for a complicated design of a plurality of cables and connectors.

The connection assembly can be designed in such a way that the HF power signal in such an assembly can be coupled to both inner conductors in common mode via capacitive coupling. As a result, the connection assembly for the HF power signal acts from the outside like a conventional coaxial cable, which makes it possible, for example, to use typical non-contact current and/or voltage sensors for alternating voltages, in particular HF signals.

In one aspect, the connection assembly is designed for a predeterminable HF impedance. This HF impedance may depend in particular embodiments on the impedance of the intended connection of the connection assembly.

Thus, in the case of a connection to a plasma process assembly, the impedance may be equal to the impedance of the plasma process assembly and in the case of a connection to an impedance adaptation circuit, the impedance may be equal to the impedance of the impedance adaptation circuit.

If the connection assembly is, for example, a coaxial cable, the impedance is determined by the inner diameter of the outer cable and the outer diameter of the inner cable and the dielectric. The inner conductors can, for example, have an approximately round outer diameter. The outer conductor is adjustable in its inner diameter. This allows the impedance of the cable to be set according to specifications.

Furthermore, the connection assembly can be designed to have a dielectric. This dielectric can be arranged between the two inner conductors or between the inner conductors and the outer conductor. The material of the dielectric can differ between the two inner conductors and the inner conductors and the outer conductor. For example, a solid material can be placed between the inner conductors, which can also serve as a holder for the two inner conductors. Air, liquid or a combination of both with a solid material, for example, can be used between the inner conductors and the outer conductor to insulate the various conductors from each other.

Such a solid dielectric may, in preferred embodiments, have a material that is compatible with a possible other material with regard to its properties such as relative permittivity and loss angle. For example, the materials used can be PTFE (polytetrafluoroethylene) or aluminum oxide. In addition, when both inner conductors are excited in common mode, the electric HF field is mainly formed between the inner and outer conductors. This means that the material of the dielectric between the surfaces of the inner conductors has only a very minor influence on the properties of the connection assembly if the two inner conductors are only a short distance apart, are at the same HF potential, and differ substantially only in their DC potential. This can further enhance the effect that the connection assembly for the HF power signal acts like a conventional coaxial cable. A small distance here means, for example, a distance of less than or equal to 3 mm, in particular embodiments less than or equal to 1 mm, and in particularly preferred embodiments less than or equal to 0.5 mm.

The connection assembly may have a current sensor, a voltage sensor, or a combined current and voltage sensor, in particular embodiments for determining the transmitted HF voltage and the transmitted HF current. This enables monitoring of the HF power signal to be integrated into the assembly.

Such a sensor can be arranged enclosing the two inner conductors of the coaxial cable. In this way, the HF voltage and/or HF current can be determined, even if it is distributed across both inner conductors.

The connection assembly may have a sensor for determining the forward and/or reverse power. Such a sensor can be designed, for example, as a directional coupler. Such a directional coupler is described, for example, in U.S. Pat. Nos. 7,755,451 B2 and in 10,490,876 B2.

In a further embodiment of the connection assembly, the inner conductors can be designed in the form of two conductor halves with a semicircular cross-section, which are separated from each other by a dielectric. This embodiment offers the advantage of a homogeneous electric field between the inner conductors and the outer conductor of the connection assembly.

In one embodiment, the connection assembly has more than two inner conductors, each of which is separated from each other by a dielectric and together forms a circular cross-section. In this way, more than two DC voltages can be supplied to the plasma with low losses and a predeterminable impedance.

The connection assembly can be used in a variety of places in systems such as plasma process flow supply systems or plasma process systems.

Thus, an embodiment of a plasma process flow supply system may include a first DC power supply, a second DC power supply, an HF power supply, and a plurality of DC blocking capacitors and HF blocking inductances, as well as a connection assembly. In such a system, connections are made between the first DC power supply and the first inner conductor of the connection assembly, the second DC power supply and the second inner conductor of the connection assembly, and the HF power supply and the two inner conductors. An HF blocking inductance is arranged between the DC power supplies and the inner conductors of the connection assembly. A DC blocking capacitor is arranged between the HF power supply and the inner conductors of the connection assembly.

A load, such as a plasma process assembly, which requires a supply of these three signals, can then be connected to the connection assembly.

Such a plasma process supply system may further have an impedance adaptation circuit which can be connected to the connection assembly. A possible load can then be connected to the impedance adaptation circuit using a connection assembly.

Such an overall system, in which a load in the form of a plasma process assembly is connected to the described plasma process flow supply system, can then be referred to as a possible embodiment of a plasma process system.

Furthermore, the connection assembly can be used in part of a plasma process system. Such a part of a plasma process system may include an impedance adaptation circuit, a plasma process assembly and the connection assembly. The connection assembly can here establish the connection between the impedance adaptation circuit and the plasma process assembly. The connection assembly allows the plasma process assembly to be supplied with two direct voltages and one HF power signal, which can be provided by two DC power supplies and one HF power supply. The HF power supply can be connected to the connection assembly via the impedance adaptation circuit. There is a plurality of options for feeding in the two DC power supplies. On the one hand, the two DC power supplies can be connected to the connection assembly via the impedance adaptation circuit. On the other hand, the DC power supplies can be connected to the connection assembly after the impedance adaptation circuit. By feeding in via the impedance adaptation circuit, the impedance adaptation circuit can be moved closer to the plasma process assembly, which can bring advantages in terms of bandwidth and impedance adaptation. An infeed after the impedance adaptation circuit has the advantage that protective measures such as DC blocking capacitors outside the impedance adaptation circuit can be dispensed with if the impedance adaptation circuit already has them.

Furthermore, the connection assembly can be used in a method for operating a plasma process in a plasma process assembly, in particular embodiments according to a previously described plasma process assembly. The connection assembly can be part of a plasma process system, in particular embodiments a previously described plasma process system. Such a method can have a plurality of steps. First, the plasma process assembly can be supplied with two direct voltages and an HF power signal. For this purpose, a first direct voltage can be provided by a first DC power supply via a first inner conductor of the connection assembly of the plasma process assembly. Simultaneously, a second direct voltage can be provided by a second DC power supply via a second inner conductor of the connection assembly of the plasma process assembly. At the same time as these two provisions, an HF power signal can be transmitted from an HF power supply to the plasma process assembly via both inner conductors of the connection assembly.

Following these steps, a plasma can be generated in the plasma process assembly.

The schematic drawings show embodiments of the invention in various stages of use and are explained in more detail in the following description.

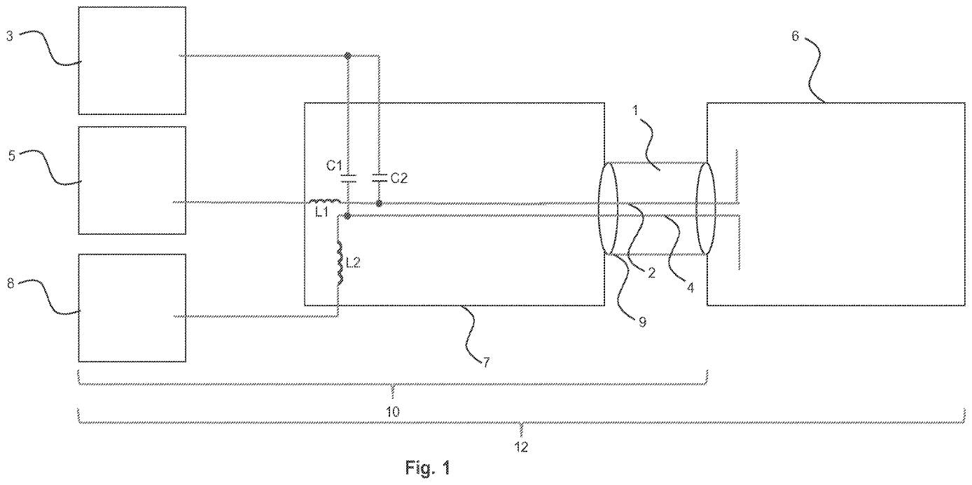

FIG. 1 shows a first embodiment of a connection assembly 1 according to the invention for an exemplary plasma process flow supply system 10 arranged in an exemplary plasma process system 12. The connection assembly 1 has two inner conductors 2, 4 and one outer conductor 9 and is part of a plasma process flow supply system 10. This plasma process flow supply system 10 additionally has two DC power supplies 5, 8, an HF power supply 3 and an impedance adaptation circuit 7 and is part of a plasma process system 12. This plasma process system 12 additionally has a plasma process assembly 6.

The connection assembly 1 connects the impedance adaptation circuit 7 and the plasma process assembly 6.

The inner conductors 2, 4 of the connection assembly 1 are designed to provide two direct voltages and to transmit an HF power signal. Each inner conductor 2, 4 can provide a different direct voltage and the HF power signal can be coupled to both inner conductors 2, 4. These signals are related to the outer conductor 9 of the connection assembly 1 and are provided by two DC power supplies 5, 8 and an HF power supply 3. The purpose of the signals is to feed in two electrodes in the plasma process assembly 6. On the one hand, these electrodes can be used as electrostatic chucks by feeding them with the DC power supplies and, on the other hand, plasma can be generated at the electrodes using the HF power signal.

The impedance adaptation circuit 7 transforms the impedance of the plasma process assembly 6 to a nominal impedance of the HF power supply 3, since the impedance of the plasma process assembly 6 can vary greatly in plasma processes. In addition, the impedance adaptation circuit 7 may contain further assemblies such as DC blocking capacitors C1, C2 or HF blocking inductances L1, L2 for filtering unwanted reverse currents.

Two DC power supplies 5, 8 and an HF power supply 3 are connected to the impedance adaptation circuit 7, which are also connected to the inner conductors 2, 4 of the connection assembly 1 via the impedance adaptation circuit 7.

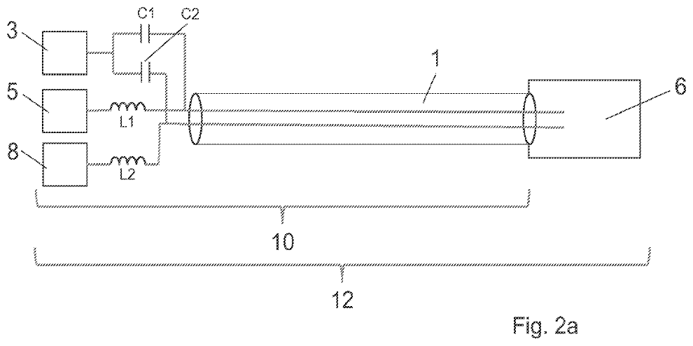

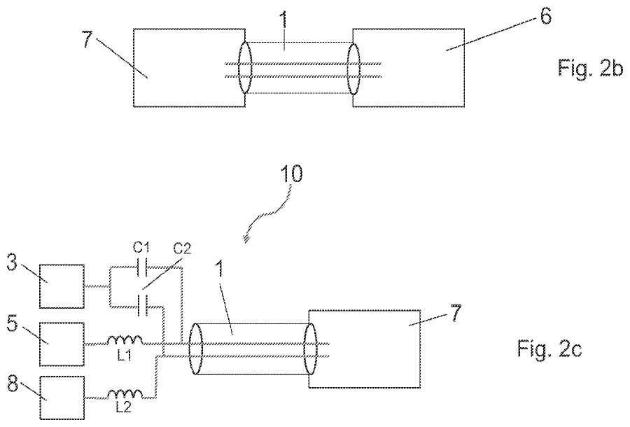

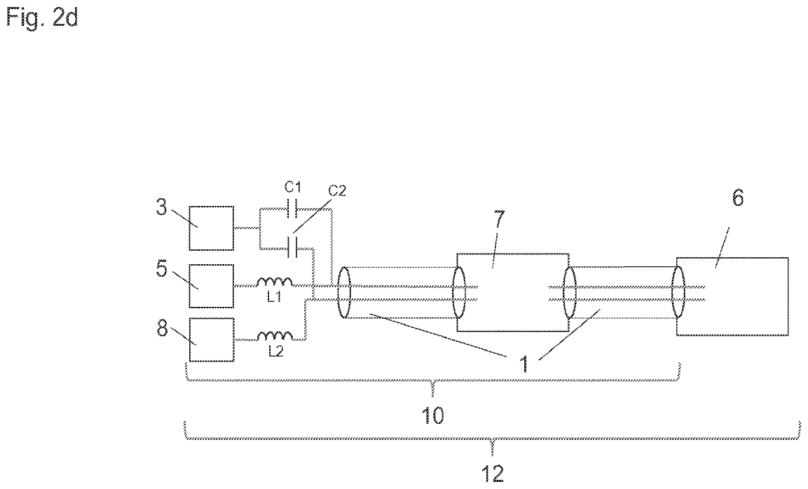

FIG. 2a shows a possibility of arranging an embodiment of the connection assembly 1 according to the invention in a plasma process system.

The plasma process system has two DC power supplies 5, 8, an HF power supply 3, a plasma process assembly 6 and the connection assembly 1.

The connection assembly 1 is arranged between the power supplies 3, 5, 8 and the plasma process assembly 6. The plasma process assembly 6 is supplied with two direct voltages and an HF power signal from the power supplies 3, 5, 8 via the connection assembly 1.

For the connection of the DC power supplies 5, 8 and the connection assembly 1, HF blocking inductances L1, L2 are inserted therebetween. To connect the HF power supply 3 and the connection assembly 1, DC blocking capacitors C1, C2 are inserted therebetween. These components are used as a protective measure against unwanted reverse currents.

FIG. 2b shows a possibility of arranging an embodiment of the connection assembly 1 according to the invention in a part of an exemplary plasma process system.

The part of the plasma process system has an impedance adaptation circuit 7, a plasma process assembly 6 and the connection assembly 1.

The connection assembly 1 is arranged between the impedance adaptation circuit 7 and the plasma process assembly 6. The connection assembly 1 allows the plasma process assembly 1 to be supplied with two direct voltages and one HF power signal, which can be provided by two DC power supplies 5, 8 and one HF power supply 3.

The HF power supply 3 can be connected to the impedance adaptation circuit 7.

The two direct voltages can be fed in via the DC power supplies 5, 8 either before or into the impedance adaptation circuit 7 or after it. The feed before or into the impedance adaptation circuit 7 brings design advantages, since the impedance adaptation circuit 7 can be moved closer to the plasma process assembly 6, which can also bring advantages with regard to the impedance adaptation and the bandwidth.

When feeding in after the impedance adaptation circuit 7, no protective measures such as DC blocking capacitors outside the impedance adaptation circuit 7 are necessary if the impedance adaptation circuit 7 already provides these.

FIG. 2c shows a possibility of arranging an embodiment of the connection assembly 1 according to the invention in an exemplary plasma process flow supply system.

The plasma process flow supply system has an impedance adaptation circuit 7, two DC power supplies 5, 8, an HF power supply 3, and the connection assembly 1.

The connection assembly 1 is arranged between the power supplies 3, 5, 8 and the impedance adaptation circuit 7. Two direct voltages and an HF power signal can be fed into the impedance adaptation circuit 7 via the connection assembly 1. These signals are provided by power supplies 3, 5, 8.

For the connection of the DC power supplies 5, 8 and the connection assembly 1, HF blocking inductances L1, L2 are inserted therebetween. To connect the HF power supply 3 and the connection assembly 1, DC blocking capacitors C1, C2 are inserted therebetween. These components are used as a protective measure against unwanted reverse currents.

A load, such as a plasma process chamber, which requires two direct voltages and an HF power signal, can be connected to the impedance adaptation circuit.

FIG. 2d shows a further possibility of arranging an embodiment of the connection assembly 1 according to the invention in an exemplary plasma process system.

The plasma process system has a plasma process assembly 6, an impedance adaptation circuit 7, two DC power supplies 5, 8, an HF power supply 3, and the connection assembly 1.

The connection assembly 1 is arranged once between the plasma process assembly 6 and the impedance adaptation circuit 7 and once between the impedance adaptation circuit 7, and the power supplies 3, 5, 8.

The plasma process assembly 6 is supplied with two direct voltages and an HF power signal via the connection assembly 1. The signals are provided by power supplies 3, 5, 8.

For the connection of the DC power supplies 5, 8 and the connection assembly 1, HF blocking inductances L1, L2 are inserted therebetween. To connect the HF power supply 3 and the connection assembly 1, DC blocking capacitors C1, C2 are inserted therebetween. These components are used as a protective measure against unwanted reverse currents.

The impedance adaptation circuit 7 transforms the load impedance of the plasma process assembly 6 to a nominal impedance of the HF power arrangement 3.

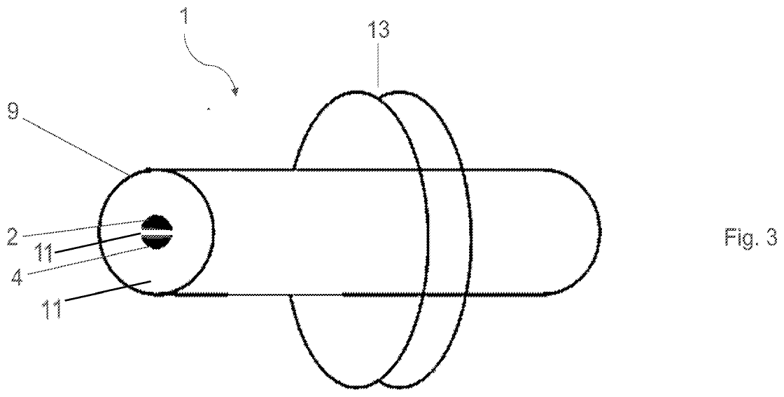

FIG. 3 shows an embodiment of the connection assembly 1 according to the invention with a combined sensor, in particular a current and voltage sensor 13. A current sensor in such an application is described, for example, in U.S. Pat. No. 7,321,227 B2. This can be supplemented by an additional voltage sensor, e.g., a capacitive voltage sensor. Such a combined current and voltage sensor 13 is described in US 2012/0223697 A1, for example. In addition to the current and voltage sensor 13, FIG. 3 shows the two inner conductors 2, 4 and the outer conductor 9 of the connection assembly 1.

The connection assembly 1 may also have a sensor for determining the forward and/or reverse power. Such a sensor can be designed, for example, as a directional coupler. Such a directional coupler is described, for example, in U.S. Pat. Nos. 7,755,451 B2 and in 10,490,876 B2.

In FIG. 3, the dielectric 11 is also shown between the inner conductors 2, 4, and between the inner conductors 2, 4 and the outer conductor 9.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A connection assembly for a plasma process flow supply system comprising:
a first inner conductor configured to provide a first direct voltage by means of a first direct current (DC) power supply;
a second inner conductor configured to provide a second direct voltage by means of a second DC power supply; and
an outer conductor which surrounds the first and second inner conductors to shield the first and second inner conductor and displays the reference potential of the first and second inner conductors,
wherein the connection assembly is configured to be connected to:
a plasma process assembly, the first and second DC power supply and a high frequency (HF) power supply, or
an impedance adaptation circuit and a plasma process assembly, and/or
an impedance adaptation circuit, the first and second DC power supply, and an HF power supply, and
wherein the connection assembly is configured to guide an HF power signal related to the outer conductor via the first and second inner conductors to supply the plasma process assembly with HF power by means of the HF power supply.

2. The connection assembly according to claim 1, wherein the connection assembly is configured such that the HF power signal can be coupled to both the first and second inner conductors in common mode via capacitive coupling.

3. The connection assembly according to claim 1, wherein the connection assembly comprises a dielectric arranged between:
the first and second inner conductors and
the first and second inner conductors and the outer conductor.

4. The connection assembly according to claim 3, wherein a material of the dielectric between the first and second inner conductors and the material of the dielectric between the first and second inner conductor and the outer conductor differ.

5. The connection assembly according to claim 1, wherein the connection assembly comprises a sensor which is configured as a current sensor, a voltage sensor, and/or a combined current and voltage sensor.

6. The connection assembly according to claim 1, wherein the first and second inner conductors are configured in the form of two conductor halves with a semicircular cross-section and are separated from one another by a dielectric.

7. The connection assembly according to claim 1, wherein the connection assembly is configured for a predeterminable HF impedance, which is based on an impedance of an intended connection of the connection assembly.

8. A plasma process flow supply system comprising the first DC power supply, the second DC power supply, the HF power supply and the connection assembly according to claim 1, which establishes the following connections:
connection of the first DC power supply to the first inner conductor of the connection assembly;
connection of the second DC power supply to the second inner conductor of the connection assembly; and
connection of the HF power supply to both the first and second inner conductors of the connection assembly

9. The plasma process flow supply system according to claim 8, further comprising an impedance adaptation circuit configured to be connected to the first DC power supply, the second DC power supply, and the HF power supply by means of the connection assembly.

10. The plasma process flow supply system according to claim 9, wherein a further connection assembly is connected to the impedance adaptation circuit for connection to a load.

11. The plasma process system comprising a plasma process flow supply system according to claim 8 and a plasma process assembly connected via the connection assembly, the plasma process assembly comprising two electrodes for connecting one of the first or second inner conductors in each case.

12. A part of a plasma process system comprising an impedance adaptation circuit, a plasma process assembly, and the connection assembly according to claim 1, which establishes a connection between the impedance adaptation circuit and the plasma process assembly.

13. A method for operating a plasma process in a plasma process assembly in a plasma process system, comprising the steps of:
providing a first direct voltage via a first inner conductor of a connection assembly to a plasma process assembly by means of a first direct current (DC) power supply;
providing a second direct voltage via a second inner conductor of a connection assembly to a plasma process assembly by means of a second DC power supply;
transmitting a high frequency (HF) power signal from the HF power supply to the plasma process assembly via the first and second inner conductors of the connection assembly; and
generating plasma in the plasma process assembly.
